(19) United States
(12) Patent Application Publication
(10) Pub. No.: US 2009/0188438 A1
(43) Pub. Date: Jul. 30, 2009

(54) Device for attaching an artificial tail to an animal

(76) Inventor: Celina E. Schmucker, Rice, VA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/010,696

(22) Filed: Jan. 29, 2008

(51) Int. Cl. A01K 13/00

(52) U.S. Cl. 119/601; 119/600; 119/607

(57) ABSTRACT

The device for attaching an artificial tail to an animal is a device for securing an upper portion of an artificial animal tail to a portion of the animal's natural tail. The device includes a longitudinally extending strap and a laterally extending strap, with the longitudinally extending strap being joined to the laterally extending strap adjacent respective first ends thereof. The laterally extending strap is positioned orthogonal to the longitudinally extending strap. In use, the longitudinally extending strap extends in the horizontal direction, and the laterally extending strap extends in the vertical direction. The longitudinally extending strap is looped around the upper portion of the artificial tail and a portion of the animal's natural tail, and the laterally extending strap is similarly looped around the artificial tail and a portion of the animal's natural tail to secure the artificial tail to the natural tail in both lateral and longitudinal directions.

### BACKGROUND OF THE INVENTION

1. Field of the Invention

The present invention relates to animal husbandry devices, and particularly to a device for attaching an artificial tail to an animal.

2. Description of the Related Art

Competitive horseback riding is a popular form of entertainment. During a typical equestrian competition, the performance of various gaits and steps by the horse are judged for form and appearance. Horse showing is similarly popular, and requires scoring based upon form and appearance. In addition to the appearance of the step or maneuver, the physical appearance of the horse is important in competition, with grooming being a particularly important in horse competitions.

The tail of the horse is one of the numerous body parts judged for appearance and grooming. Due to both its location and the continuous use by the horse (to swat flies), the tail tends to become dirty and tangled soon after grooming, almost always requiring a great deal of effort to prepare the horse's tail for competition.

Tail covers are sometimes used prior to the competitive event, in order to protect the animal's real tail. The tail covers are in the form of a bag or other enclosure, which is attached to the horse by fastening a strap that extends over the back of the animal, and typically wraps around the neck of the horse. Thus, traditional tail covers are difficult to mount on the horse, and can irritate the horse when worn. It should be noted that tail covers are not used during showing of the horse, but only serve to protect the horse's tail when the animal is not being shown.

Artificial tails are a popular alternative to tail covers. Even with tail covers, horses may still damage or destroy their tails through regular activities. Thus, artificial tails are permitted to be attached in order to enhance the natural tail when showing and competing. Such artificial tails may be attached for everyday usage as well, if the animal's tail is severely damaged. The artificial tail includes gathered hair (either real or artificial), which is pre-groomed and chosen for its decorative appearance. A typical artificial tail 14 is illustrated in FIG. 4. As shown, the artificial tail includes an upper, looped portion 40. A portion of the horse's natural tail is secured to the looped portion of the artificial tail, allowing the pre-groomed, decorative artificial hair to mingle with the natural hair of the animal.

Such artificial tails are typically bound to the horse's natural tail through some form of adhesive tape, such as electrical tape. The use of adhesive tape, however, may be painful or physically damaging to the horse. The tape is further difficult to apply and to remove. It would be desirable to provide a device for easily attaching the artificial tail to the horse that does not cause the horse unnecessary pain or discomfort, and that may be quickly applied and removed. Such a desired device would be safer for use by both the equestrian and by the horse.

Further, an animal's tail may be shortened due to various ailments, such as mange, affecting the skin, hair or fur. It may be desirable to attach an artificial tail to the animal to improve appearance, for functional use, or for the animal's psychological well being.

Thus, a device for attaching an artificial tail to an animal solving the aforementioned problems is desired.

### SUMMARY OF THE INVENTION

The device for attaching an artificial tail to an animal is a device for securing an upper portion of an artificial animal tail to a portion of the hair of the animal's natural tail. The device includes a longitudinally extending strap having opposed first and second ends, and a laterally extending strap also having opposed first and second ends. The longitudinally extending strap is joined to the laterally extending strap adjacent the respective first ends thereof. The juncture of the longitudinally extending strap and the laterally extending strap define an overlapping region. The laterally extending strap is positioned substantially orthogonal to the longitudinally extending strap. In use, the longitudinally extending strap may extend in the horizontal direction, and the laterally extending strap may extend in the vertical direction.

A releasable fastener, such as a hook and loop fastener, releasably secures the second end of the laterally extending strap to the overlapping region. Similarly, a releasable fastener, such as a hook and loop fastener, releasably secures the second end of the longitudinally extending strap to a central region thereof. A longitudinal buckle extends from the first end of the longitudinal strap for insertion of the second end therethrough, allowing the longitudinally extending strap to be formed into a length-adjustable longitudinal loop. Similarly, a lateral buckle extends from the first end of the lateral strap for insertion of the second end therethrough, allowing the laterally extending strap to be formed into a length-adjustable lateral loop.

In use, the user forms a braid from a portion of natural hair of the natural tail of the animal and inserts the braid through an upper looped portion of the artificial tail. Preferably, the remainder of the hair of the natural tail is bound by a hair clip or the like to maintain access to the braid.

The longitudinal loop is then formed from the longitudinally extending strap, and is wrapped around the braid and the looped portion in the longitudinal (horizontal) direction. Next, the lateral loop is formed from the laterally extending strap, and the lateral loop is wrapped around the braid and the looped portion in the lateral (vertical) direction.

The second end of the laterally extending strap is then secured to the overlapping region in order to secure the lateral loop to the braid and the looped portion, and then the second end of the longitudinally extending strap is secured to a central portion thereof to secure the longitudinal loop to the braid, the lateral loop and the looped portion, thus securing the artificial tail to the hair braid in both the lateral and longitudinal directions.

These and other features of the present invention will become readily apparent upon further review of the following specification and drawings.

### BRIEF DESCRIPTION OF THE DRAWINGS

FIG. 1 is an environmental, perspective view of a device for attaching an artificial tail to an animal according to the present invention.

FIG. 2 is a perspective view of the device for attaching an artificial tail to an animal according to the present invention.

FIG. 3 is an environmental, perspective view showing a first step for attaching an artificial tail to a horse using the device of the present invention.

FIG. 4 is a perspective view showing an artificial tail for attachment to an animal with the device of the present invention.

FIG. 5 is an environmental, perspective view showing an intermediate step for attaching the artificial tail to a horse using the device of the present invention.

FIG. 6 is an environmental, perspective view illustrating the device for attaching the artificial tail to an animal according to the present invention being applied to the natural tail of the animal.

FIG. 7 is an environmental, perspective view showing the longitudinally extending strap of the device of the present invention looped around the horse's natural tail and being drawn through a buckle.

FIG. 8 is an environmental, perspective view showing the hook and loop portions of the longitudinally extending strap of the device of the present invention about to be fastened together.

FIG. 9 is an environmental, perspective view showing the device for attaching the artificial tail to an animal according to the present invention securing the artificial tail to the natural tail of the animal.

Similar reference characters denote corresponding features consistently throughout the attached drawings.

### DETAILED DESCRIPTION OF THE PREFERRED EMBODIMENT

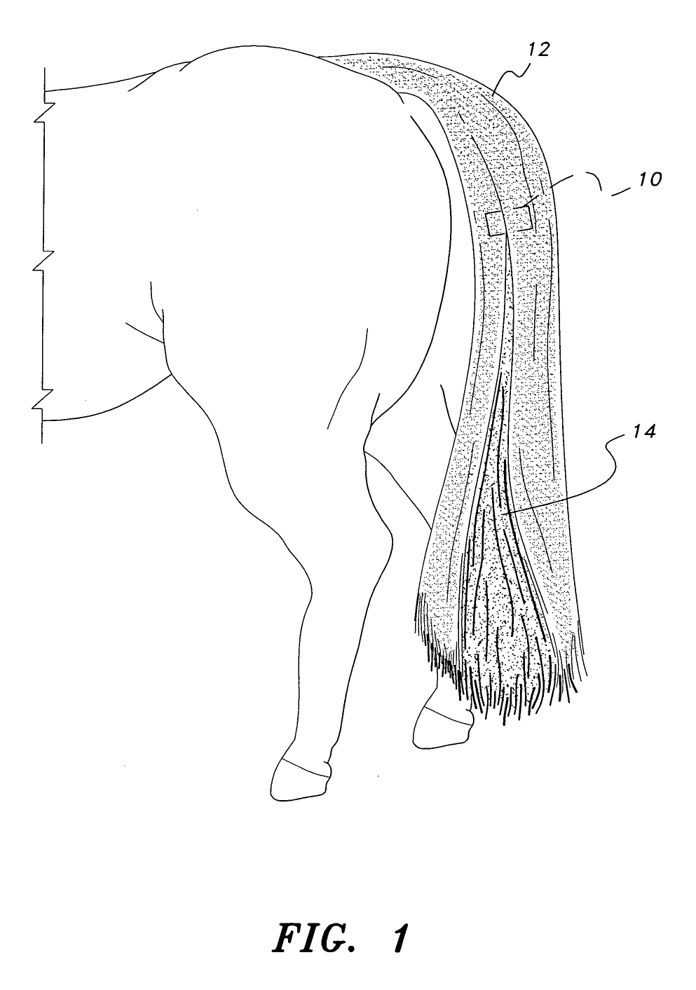

The present invention is directed towards a device 10 for attaching an artificial tail to an animal, such as the exemplary horse shown in FIG. 1. In FIG. 1, artificial tail 14 is shown attached to the natural tail 12 of a horse, the device 10 being covered by the hair of the natural tail 12 and shown in phantom. It should be understood that device 10 may be used for the attachment of an artificial tail to any animal, a horse being shown in FIG. 1 for exemplary purposes only.

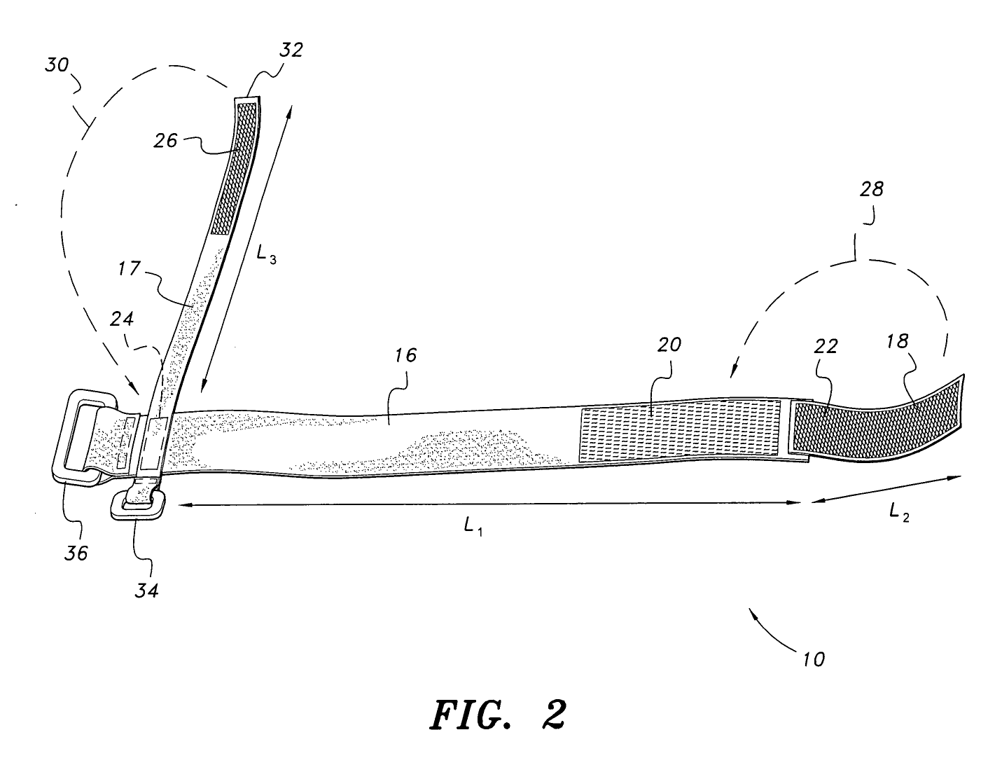

As best shown in FIG. 2, device 10 includes a flexible, longitudinally extending horizontal strap 16, preferably formed from an elastic material, and a flexible, laterally extending vertical strap 17. It should be understood that the horizontal and vertical orientations are shown for exemplary purposes only. Horizontal strap 16 and vertical strap 17 each have opposed first and second ends, with horizontal strap 16 being permanently secured to vertical strap 17 adjacent the first ends thereof by stitching or the like, so that horizontal strap 16 extends orthogonal to vertical strap 17.

Horizontal strap 16 includes a main portion having a length of L₁ and an end portion having a length of L₂, as shown. In the preferred embodiment, L₁ is approximately nine inches in length and L₂ is approximately three inches in length. The second end 18 of horizontal strap 16 is adapted for being releasably secured to the main portion by any suitable releasable fastener. In the embodiment shown in the drawings, a hook and loop fastener is used, with the hook portion 20 of the fastener being attached to the main portion of strap 16 and the loop portion 22 of the fastener being attached to the end portion 18, as shown (although it should be understood that the positioning of the portions of the hook and loop fasteners may be reversed).

The vertical strap 17 also includes a main portion and second end 32, with a loop portion 26 of a hook and loop fastener being formed on the main portion thereof for releasable attachment to a hook fastener 24 permanently secured to the opposite surface of the overlapping junction of vertical strap 17 and horizontal strap 16. Vertical strap 17 preferably has a length L₃ of approximately ten inches. It should be understood that the positioning of the hook and loop fasteners may be reversed. A buckle 36 extends from the first end of strap 16 opposite second end 18, and, similarly, a buckle 34 extends from the first end of strap 17 opposite second end 32. Both buckles 34 and 36 are adjacent the overlapping portions of longitudinally extending strap 16 and laterally extending strap 17.

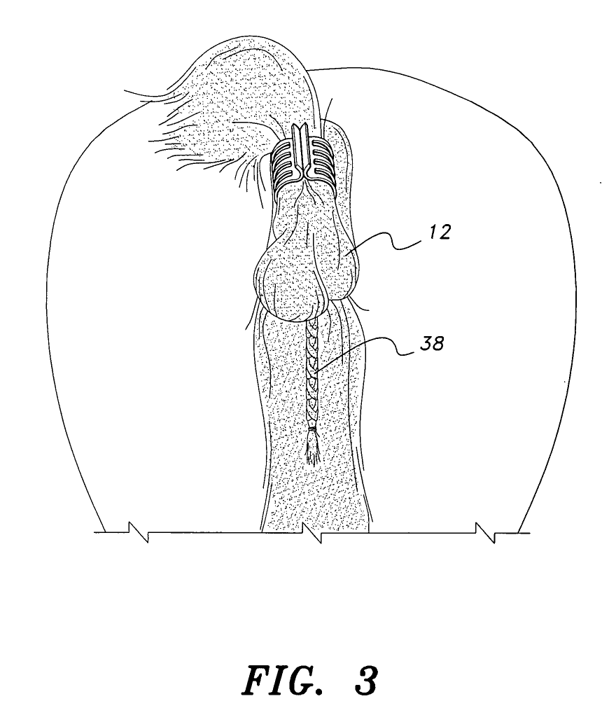

FIGS. 3-9 illustrate the method of attaching artificial tail 14 to the natural tail 12 using device 10. In FIG. 3, a braid 38 is formed from hair of the natural tail 12, and a portion of the hair of natural tail 12 is bound by a clip or the like in order to provide the user with access to braid 38. The artificial tail 14 will be secured to the braid 38 formed from natural hair.

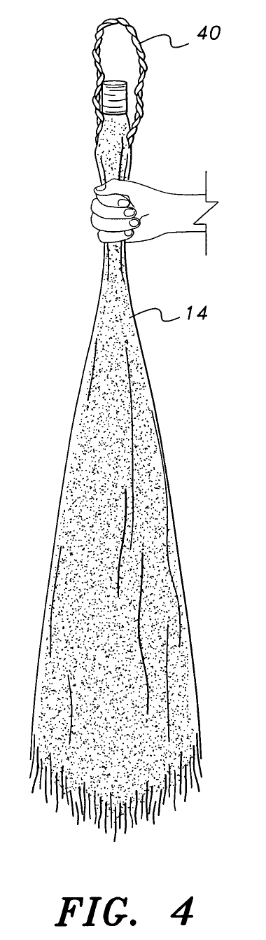

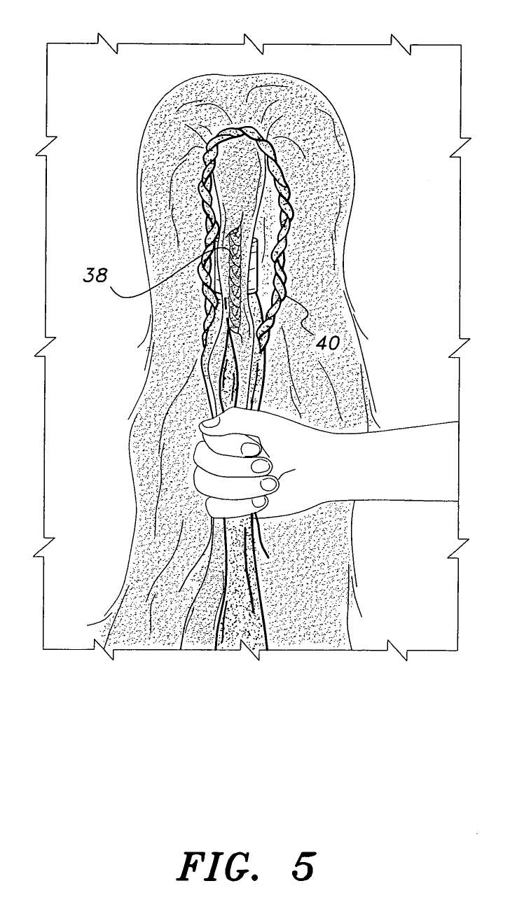

A conventional artificial tail 14 is shown in FIG. 4. Artificial tail 14 includes a loop 40 formed on the upper end thereof. FIG. 5 shows the braid 38 of natural hair passing through loop 40 of artificial tail 14.

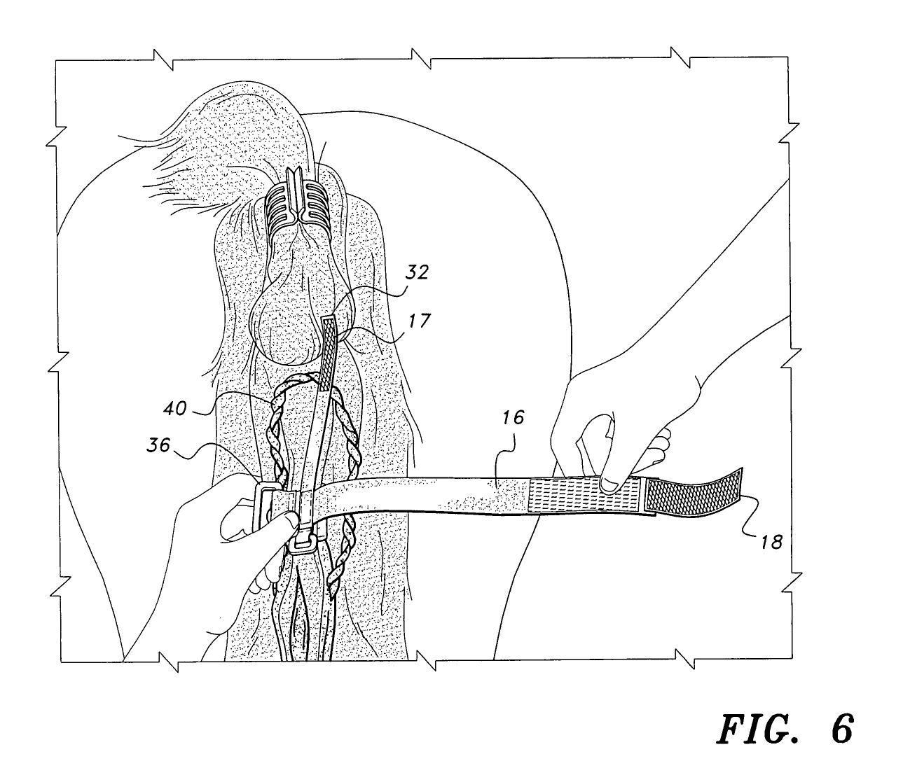

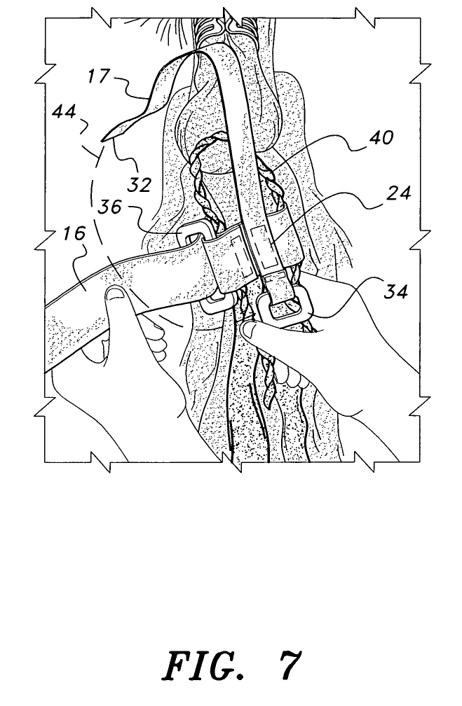

In FIG. 6, device 10 is positioned so that the junction between vertical strap 17 and horizontal strap 16 is positioned over the loop 40 and the braid 38, with vertical strap 17 extending along a substantially vertical axis, and horizontal strap 16 extending along a substantially horizontal axis. As shown in FIG. 7, the horizontal strap 16 is folded or looped around loop 40 and braid 38, and end 18 is inserted through buckle 36 to secure the loop 40 and braid 38 therein. The horizontal strap 16 is pulled tightly through buckle 36 to adjustably tighten the looped horizontal strap 16 about the braid 38 and the loop 40, thus partially securing the loop 40 to the braid 38.

Dashed attachment line 44 shows that second end 32 of vertical loop 17 is next drawn through buckle 34, with vertical strap 17 passing behind loop 40 and braid 38, forming a second, vertical loop, securing the loop 40 to the braid 38. Vertical strap 17 is pulled through buckle 34 and tightened, with loop fasteners 26 attaching to hook fastener 24, thus securing the loop 40 to the braid 38.

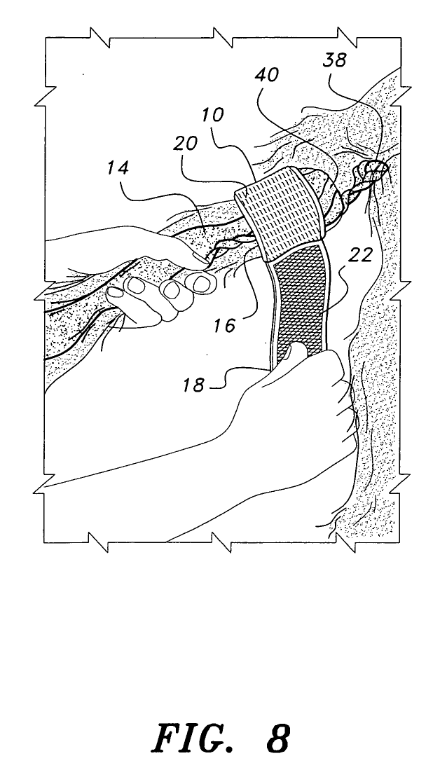

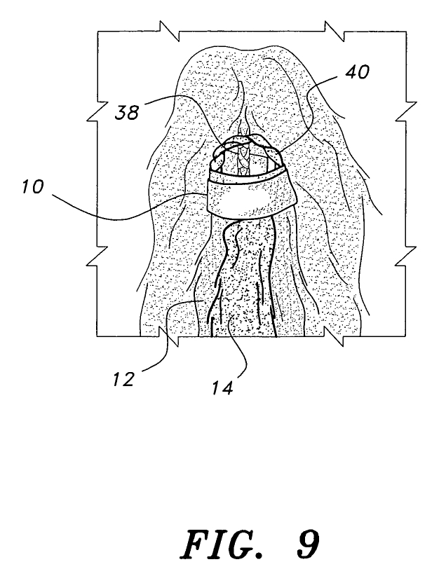

As shown in FIG. 8, once the vertical strap 17 has been tightened and fastened, horizontal strap 16 is tightened and adjusted and the loop fastener 22 of end portion 18 is secured to the hook fastener 20 of the main portion of strap 16, as indicated by the arrow 28 of FIG. 2. Thus, the loop 40 is secured to the braid 38 (securing the entire artificial tail 14 to the braid 38) in both the horizontal and vertical directions, best shown in FIG. 9. The hair clip can be removed so that the horse's natural tail hair covers the device 10.

It is to be understood that the present invention is not limited to the embodiment described above, but encompasses any and all embodiments within the scope of the following claims.

I claim:

1. A device for attaching an artificial tail to an animal, comprising:
a longitudinally extending strap having opposed first and second ends and a central region extending between the first and second ends;
a laterally extending strap having opposed first and second ends, the longitudinally extending strap and the laterally extending strap being permanently joined adjacent the respective first ends thereof, forming a junction where the straps overlap, the laterally extending strap substantially orthogonal to the longitudinally extending strap;
means for releasably securing the second end of the laterally extending strap to the junction of the longitudinally and laterally extending straps;
means for releasably securing the second end of the longitudinally extending strap to the central region of the longitudinally extending strap, the second end being folded back to overlap a portion of the central region; and
means for securing the laterally extending strap into a lateral loop.

2. The device for attaching an artificial tail to an animal as recited in claim 1, wherein said means for releasably securing the second end of the laterally extending strap to the junction of the longitudinally and laterally extending straps comprises mating hook and loop fasteners.

3. The device for attaching an artificial tail to an animal as recited in claim 2, wherein said means for releasably securing the second end of the longitudinally extending strap to the central region of the longitudinally extending strap comprises mating hook and loop fasteners.

4. The device for attaching an artificial tail to an animal as recited in claim 1, wherein said means for securing the laterally extending strap into the lateral loop comprises a lateral buckle extending from the first end of the laterally extending strap.

5. The device for attaching an artificial tail to an animal as recited in claim 4, wherein said means for securing the longitudinally extending strap into the longitudinal loop comprises a longitudinal buckle extending from the first end of the longitudinally extending strap.

6. The device for attaching an artificial tail to an animal according to claim 1, wherein said longitudinally extending strap is made from an elastic material.

7. A method of attaching an artificial tail to an animal, comprising the steps of:
forming a braid from a portion of the animal's natural tail hair;
inserting the braid through a loop formed at an upper end of the artificial tail;
placing orthogonally overlapped flexible straps adjacent the natural hair braid and artificial tail loop, one of the straps being aligned parallel to the natural tail hair braid and the artificial tail, and one of the straps being aligned normal to the natural tail hair braid and the artificial tail;
forming the strap parallel to the natural tail hair braid and the artificial tail into a second loop around the braid and the loop;
tightening the second loop;
securing the second loop with a first releasable fastener;
wrapping the strap normal to the natural tail hair braid and the artificial tail around the second loop;
tightening the normal strap; and
securing the wrapped normal strap with a second releasable fastener.

8. The method of attaching an artificial tail to an animal as recited in claim 7, further comprising the step of binding any of the animal's unbraided natural tail hair together following said step of forming the braid.

9. The method of attaching an artificial tail to an animal as recited in claim 7, wherein said step of securing the second loop with a first releasable fastener further comprises attaching a first hook and loop fastener at an end of the parallel strap to a mating hook and loop fastener disposed on the overlapping portion of the overlapping straps.

10. The method of attaching an artificial tail to an animal as recited in claim 7, wherein said step of forming the second loop comprises inserting one end of the parallel strap through a buckle extending from an opposite end of the parallel strap.

11. The method of attaching an artificial tail to an animal as recited in claim 7, wherein said step of wrapping the normal strap around the second loop further comprises inserting one end of the normal strap through a buckle extending from an opposite end of the normal strap.

12. The method of attaching an artificial tail to an animal as recited in claim 7, wherein said step of securing the wrapped normal strap with a second releasable fastener comprises the steps of:
folding an end of the normal strap back to overlap a central region of the normal strap; and
fastening a first hook and loop fastener at the overlapping end of the normal strap to a mating hook and loop fastener disposed on the central region of the normal strap.
